(19) United States
(12) Patent Application Publication
(10) Pub. No.: US 2007/0171049 A1
(43) Pub. Date: Jul. 26, 2007

(54) Emergency response imaging system and method

(76) Inventor: Henry E. Argasinski, Clinton Township, MI (US)

Correspondence Address: HARNESS, DICKEY & PIERCE, P.L.C., P.O. BOX 828, BLOOMFIELD HILLS, MI, 48303, US

(21) Appl. No.: 11/487,957

(22) Filed: Jul. 17, 2006

Related U.S. Application Data
(60) Provisional application No. 60/700,010, filed on Jul. 15, 2005.

(51) Int. Cl. G08B 1/08; G08G 1/123; G08B 13/14

(52) U.S. Cl. 340/539.13; 340/995.1; 340/572.1

(57) ABSTRACT

An imaging system for a location generally includes a data storage device and a control module. The data storage device stores navigable actual images corresponding to positions within the location and an overhead layout of the location. The control module has an input for a navigation input device and an output for a display device. The control module determines a current navigation position based on the input, accesses the navigable actual images and the overhead layout, and controls the output to display on the display device at least one of a view of a selected navigable actual image and a view of the overhead layout. The view of the selected navigable actual image and the view of the overhead layout correspond to the current navigation position.

### CROSS-REFERENCE TO RELATED APPLICATIONS

This application claims the benefit of U.S. Provisional Application No. 60/700010, filed on Jul. 15, 2005. The disclosure of the above application is incorporated herein by reference.

### FIELD

The present teachings relate to emergency response systems and more particularly to an emergency response imaging system and method.

### BACKGROUND

In an emergency situation, access to information about the emergency location is critical to response time and to the safety of all persons involved with the emergency. For example, response personnel, such as police, fire, ambulance, swat team and other law enforcement and emergency responders are often presented with a crisis situation in an unfamiliar setting. The emergency may be a natural disaster, such as a flood, earthquake or tornado, or the like. The emergency may also be a fire, school shooting, bomb threat, terrorist situation, hostage situation, or other violent threat. Response personnel at the scene may be unfamiliar with the emergency location and may have to question those familiar with the location, assuming they are available, to gain information necessary to respond to the emergency. This may require delaying emergency response actions while information is gathered at the scene, or otherwise.

Once information about the emergency location becomes known, it must be communicated to other response personnel who may have dispersed at the scene or who may have not yet arrived. Later, additional information about the location may be needed as the response to the emergency is carried out.

While locations are sometimes equipped with video surveillance systems for internal personnel, such as security guards, such systems are often monitored from a central monitoring location within the location. These systems are useless to response personnel during an emergency unless the responding personnel are able to access the central monitoring location. Such video surveillance information cannot be efficiently communicated to other response personnel.

Quick and efficient access to emergency location information is needed to minimize response time and effectively respond to an emergency.

### SUMMARY

An imaging system for a location is provided and includes a data storage device and a control module. The data storage device stores navigable actual images corresponding to positions within the location and an overhead layout of the location. The control module has an input for a navigation input device and an output for a display device. The control module determines a current navigation position based on the input, accesses the navigable actual images and the overhead layout, and controls the output to display on the display device at least one of a view of a selected navigable actual image and a view of the overhead layout. The view of the selected navigable actual image and the view of the overhead layout correspond to the current navigation position.

In one feature, the location includes RFID devices and the control module is configured to detect the RFID devices and to receive information about a current actual position of the control module within the location based on the detection.

In other features, the imaging system includes a video camera at the location and the control module receives video images from the video camera and controls the output to display the video images on the display device.

Further areas of applicability of the present teachings will become apparent from the detailed description provided hereinafter. It should be understood that the detailed description and specific examples are intended for purposes of illustration only and are not intended to limit the scope of the teachings.

### BRIEF DESCRIPTION OF THE DRAWINGS

The present teachings will become more fully understood from the detailed description and the accompanying drawings, wherein:

FIG. 1 is a schematic illustration of an emergency response imaging system with an emergency response imaging system server;

FIG. 2 is another schematic illustration of an emergency response imaging system without an emergency response imaging system server;

FIG. 3a is a schematic illustration of an emergency response imaging system device with input device(s) and display device;

FIG. 3b is a schematic illustration of an emergency response imaging system device with an integrated display/input device;

FIG. 4 is a flowchart illustrating steps performed to install and operate an emergency response imaging system;

FIG. 5 is a screenshot of an emergency response imaging system;

FIG. 6 is a screenshot of an emergency response imaging system illustrating a overhead layout image;

FIG. 7 is a screenshot of an emergency response imaging system illustrating a navigable actual image of a cafeteria;

FIG. 8 is a screenshot of an emergency response imaging system illustrating a navigable actual image of a corridor;

FIG. 9 is a screenshot of an emergency response imaging system illustrating a navigable actual image of a corridor;

FIG. 10 is a screenshot of an emergency response imaging system illustrating a navigable actual image of a corridor;

FIG. 11 is a screenshot of an emergency response imaging system illustrating an actual image of a corridor;

FIG. 12 is a screenshot illustrating an alarm annunciator;

FIG. 13 is a screenshot illustrating a local area map image;

FIG. 14 is a schematic illustration of an emergency response imaging system with RFID devices.

FIG. 15 is a schematic illustration of an emergency response imaging system device;

### DETAILED DESCRIPTION

The following description is merely exemplary in nature and is in no way intended to limit the teachings, its application, or uses. As used herein, the term module refers to a software program, or a component of a software program, that is executed by a processor, such as a central processing unit (CPU), with memory. A module may also be implemented by an application specific integrated circuit (ASIC), an electronic circuit, a combinational logic circuit, and/or other suitable implementation means that provide the described functionality. A module may also be implemented by a combination of software and hardware, as can be appreciated.

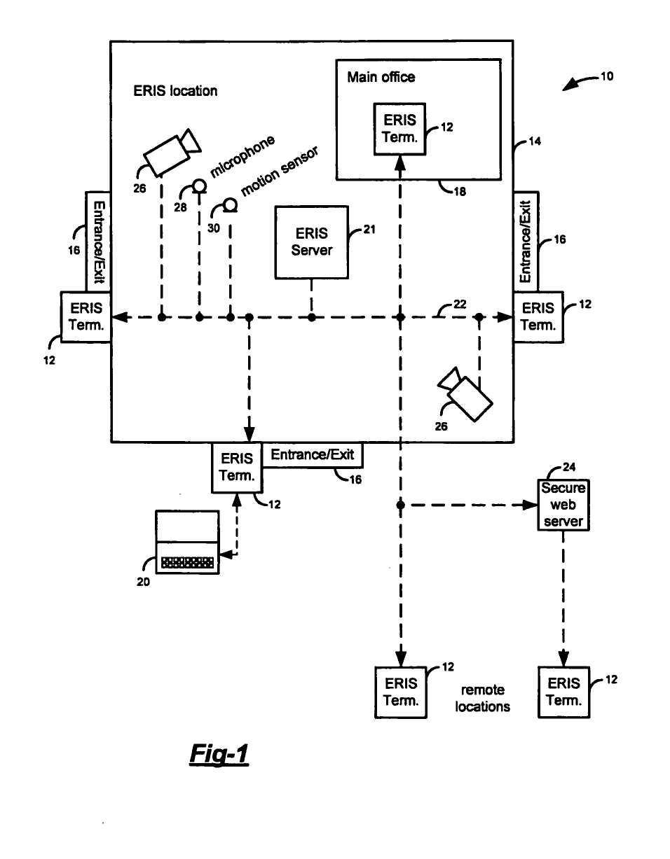

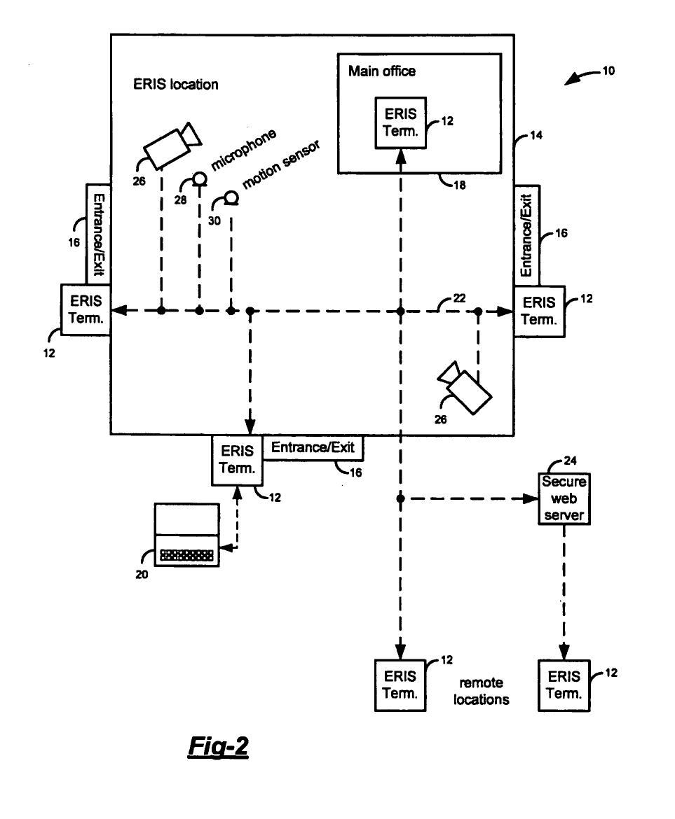

Referring now to FIGS. 1 and 2, an emergency response imaging system (ERIS) 10 may include ERIS terminals 12 at various locations. The ERIS 10 may be installed at any location 14 where access to location information is desired. For example, the location 14 may be a public building, such as a school, a library, court house, post office, airport, government building, or the like. The location 14 may also be a home, an apartment building, an office building, a store, a sports complex, an arena, a theater, a casino, or the like. The location 14 may also be a ship, a plane, or other transportation vehicle. Further the location 14 may be outdoors, such as a park, a docking area, a parking lot, or the like. As ,can be appreciated, the ERIS 10 may be installed at any location 14 where access to information about the location 14 may be desired, and, particularly, where access to information about the location 14 may be desired for emergency response.

The ERIS terminals 12 are modules and may provide access to location information, including, for example, location overhead layouts (e.g., floor plans), actual images of the location, video surveillance, and other information, as described in more detail below. The ERIS terminals 12 may be located at Entrance/Exit locations 16. The ERIS terminals 12 may be located proximate, or nearby, the location 14 such that response personnel may easily access an ERIS terminal 12. ERIS terminals 12 may also be located around the perimeter of the location 14, in an adjacent parking lot, an adjacent building, or at another suitable location accessible to response personnel. ERIS terminals 12 may also be located remotely, for example, at emergency personnel headquarters, such as a police or fire station. ERIS terminals 12 may also be located within the location, such as in a main office 18 or a security post. ERIS terminals 12 may also be located in vehicles, such as a police vehicle, helicopter, mobile command station, or other vehicle location.

The ERIS terminals 12 may include a network interface such that response personnel may access the ERIS terminals 12 with a computing device 20, such as a laptop computer, personal data assistant (PDA), or other suitable computing device, connected to the network interface. Such ERIS terminals 12 are referred to as connection-only ERIS terminals. To access the ERIS 10, a computing device 20 may be connected to the network interface.

Alternatively, the ERIS terminals 12 may include an integrated computing device 20, such as a dedicated laptop computer, desktop computer, PDA, cell phone, or other suitable computing device. The integrated computing device 20 may include a touch screen input-output device. In such case, response personnel may be provided walk-up access to an ERIS terminal 12 without any auxiliary portable computing equipment. Such ERIS terminals 12 are referred to as walk-up ERIS terminals 12.

The computing device 20 may be housed in a shockproof lockable housing at the location. In this way, the computing device 20 may be protected from the location environment and available only to authorized personnel.

The computing device 20 may also include a wireless connection. In such case, the computing device 20 may be portable and may communicate with an ERIS terminal 12, or with multiple ERIS terminals 12, via the wireless connection. For example, during an emergency, response personnel may access the computing device 20 from a lockable housing and proceed to move around or within the location with the computing device 20. The computing device 20 may continue data communication with one or more ERIS terminals 12, to continue to provide location information to the response personnel.

In addition, a portable computing device 20 may be stored at emergency personnel headquarters, such as a police station or fire station, or stored with response vehicles. In this way, a computing device 20 may be carried to the location 14 by response personnel. Further, the computing device 20 may be used at more than one location 14, such that a single computing device 20 may be operable with multiple ERIS's 10 at various locations 14. By carrying a single computing device 20, response personnel may be prepared to respond at any ERIS equipped location.

The location 14 may be equipped with some connection-only ERIS terminals 12 and some walk-up ERIS terminals 12. Both types of ERIS terminals 12 may be enclosed in a suitable lock-box, accessible only to response personnel. The lock-boxes may be configured such that a notification signal is broadcast to building personnel, emergency personnel, or a central emergency dispatch when a lock-box is accessed.

The location 14 may be equipped with wireless networking capabilities. In such case, the ERIS 10 may communicate with ERIS terminals 12 via the wireless network. In this way, a portable computing device 20 may act as an ERIS terminal 12 throughout the location. As described in more detail below, the location may also be equipped with RFID devices. In such case, a portable computing device 20 may determine information about its position and surroundings based on received RFID signals.

The ERIS 10 may include an ERIS server 21 connected via a network 22 to each of the ERIS terminals 12. The network 22 may be a wired or a wireless network. The network 22 may be dedicated to ERIS activity only and separate from normal data communication. Alternatively, the network 22 may be integrated with the building's data and/or voice communication networks. In such case, the ERIS network 22 may be connected to, or part of, a local area network, an intranet, the internet, or other suitable network means.

Access to the ERIS 10 via the network 22 may be protected by passwords or other data security means. ERIS data communication may be protected by encryption and made via secure network connections such that only authorized persons may gain access to the ERIS 10. In addition, the ERIS 10 may include security levels corresponding to various levels of access to ERIS functionality and data. A secure web server 24 may be connected to the network 22 so that the ERIS 10 is accessible via the internet. In this way, authorized personnel may be able to login to the ERIS 10 remotely.

As described in more detail below, the ERIS server 21 may store ERIS data, including the overhead layouts (e.g., floor plans), diagrams, actual images of the location, evacuation routes, local area maps, aerial views, building schematics, and other location information and data.

Various server/client configurations between the ERIS server 21 and ERIS terminals 12 may be used. For example, the ERIS server 21 may contain ERIS data only. In such case, the ERIS server 21 may receive data requests from the ERIS terminals 12 executing ERIS software. Alternatively, execution of the ERIS software may be divided between the ERIS server 21 and the ERIS terminals 12. Further, multiple ERIS servers 21 may be included to communicate with different groupings of ERIS terminals 12. In addition, multiple redundant ERIS servers 21 may be included to communicate with ERIS terminals 12.

Additionally, the ERIS 10 may not include an ERIS server 21. As shown in FIG. 2, ERIS terminals 12 may stand alone. In such case, each of the ERIS terminals 12 may contain all of the ERIS data. All of the ERIS data may be duplicated on each of the ERIS terminals 12. In such case, updates to ERIS data may be carried out on each of the ERIS terminals 12. The ERIS terminals 12 in such case may be isolated from network disturbances. For example, if part of a location is destroyed, including other ERIS terminals 12, the ERIS data on other ERIS terminals 12 may remain in tact.

Further, the ERIS 10 may include an ERIS server 21 for data update purposes only. In such case, the ERIS terminals 12 may each contain all of the ERIS data. However, the ERIS data on each of the ERIS terminals 12 may be updated centrally by the ERIS server 21. The ERIS terminals 12 in such case may stand alone during operation, while remaining centrally updatable.

The ERIS 10 may be networked with other location systems such as a fire alarm system, a security system, an HVAC system, a lighting system, an audio system, a video system, an elevator system, and the like. In this way, the ERIS 10 may retrieve data from other location systems for use with the ERIS 10.

Video cameras 26 may be connected to the ERIS network 22. Live video surveillance data may be fed to the ERIS terminals 12. In this way, live video surveillance may be accessible to response personnel at each ERIS terminal 12. The video cameras 26 may be controllable by a user at an ERIS terminal 12, such that a user may control pan, tilt, and zoom functions of a video camera 26 from an ERIS terminal 12.

The video cameras 26 may be equipped with microphones 28. Microphones 28 may also be separately connected to the ERIS network 22. The microphone audio data may be fed to the ERIS terminals 12. In this way, live audio surveillance may be accessible to response personnel at each ERIS terminal 12. The microphones 28 may be configured to selectively communicate live audio data to the ERIS network 22, and/or ERIS terminals 12. For example, the microphones 28 may be triggered by a loud noise such as a gun shot or explosion. Alternatively, the microphones 28 may be selectively activated by response personnel using the ERIS 10.

Motion sensors 30 may be connected to the ERIS network 22. In this way, live motion data may be accessible to emergency response personnel at each of the ERIS terminals 12. The motion sensors 30 may detect movement throughout the location 14, and may be used to locate persons within the location 14 or track movement throughout the location.

The video cameras 26 and microphones 28 may be coordinated with the motion sensors 30, such that a live video feed from a video camera 26 is displayed, and audio data projected, on an ERIS terminal 12 when motion is detected in the vicinity of the video camera 26 or microphone 28.

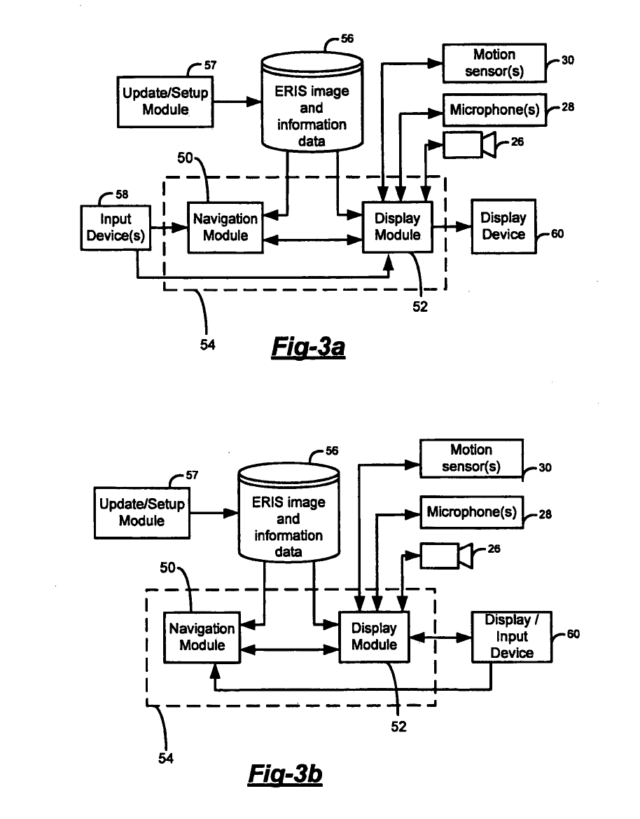

Referring now to FIGS. 3a and 3b, an ERIS 10 includes a control module 54 interfaced with an ERIS image and information data storage device 56. The control module 54 may include a navigation module 50 and a display module 52. Initially, an update/setup module 57 is used to initialize ERIS images and information in the storage device 56. During ERIS operation, the navigation module 50 retrieves a selected ERIS file for viewing, such as an overhead layout (e.g., floor plan), an actual image, a local area map, an evacuation plan, or the like, from the storage device 56 based on user input received from an input device 58, as shown in FIG. 3a. The input device 58 may be a keyboard, mouse, joystick, directional arrows, or other suitable input device. As shown in FIG. 3b, the navigation module 50 may receive input from a display/input device 60, such as a touch screen display device.

The navigation module 50 communicates the selected image to the display module 52 which displays the selected image on the display device 62, or on the display/input device 60. The display module 52 displays the selected image based on user input received from the input device 58 or from the display/input device 60. As described in more detail below, for a selected image the display module 52 may perform display operations including pan left, pan right, pan up, pan down, zoom in, zoom out, or other suitable display operations.

Displayed images may be navigable in that they may contain links to other ERIS images. An actual image of a hallway, for example, may contain an embedded link to an image of a room adjacent to the hallway. When the user selects the link, the display module 52 communicates information related to the selected link to the navigation module 50. The navigation module 50 retrieves the newly selected image from the storage device 56 for display by the display module 52. In this way, the user may view and navigate the various navigable images of the location 14. The navigable images may be linked in a manner corresponding to the layout of the location, such that adjacent areas are linked together. Response personnel utilizing the ERIS 10 may view pertinent information related to the layout of the location with minimal effort and time. In this way, time previously wasted trying to discern location information may be spent developing, and executing, a response strategy.

The display module 52 is connected to live video cameras 26. The video camera location information is stored in the data storage device 56. Links to video cameras data may be embedded in other ERIS images, such as an overhead layout (e.g., floor plan) or an actual image. When the user selects one of the embedded links to the video cameras, live video surveillance may be displayed by the display module 52 on the display device 62 or display/input device 60.

Likewise, the display module 52 is connected to microphones 28 and motion sensors 30. Links to the microphone and motion sensor data may be embedded in other ERIS images, such as an overhead layout (e.g., floor plan) or an actual image.

The video cameras 26 may be stationary, rotating, or controllable. The display module 52 may control the video cameras 26 based on user input. The video camera 26 may be controlled to pan left, pan right, pan up, pan down, zoom in, zoom out, or perform other suitable display operations.

The control module 54, including the navigation module 50 and display module 52, described above and shown in FIGS. 3a and 3b may be implemented and connected in various ways. Specifically, an ERIS terminal 12 may include the control module 54, the navigation module 50, the display module 52, the display device 62, or the display/input device 60. The ERIS server 21 may include the data storage device 56 or the update/setup module 57. In addition, an ERIS terminal 12 may comprise a network interface only. In such case, a computing device 20 connected to the network interface may include the control module 54, the navigation module 50, the display module 52, the display device 62, the input device 58, or the display/input device 60. As can be appreciated, the ERIS devices and modules may be implemented and connected in various ways to accomplish the described functionality.

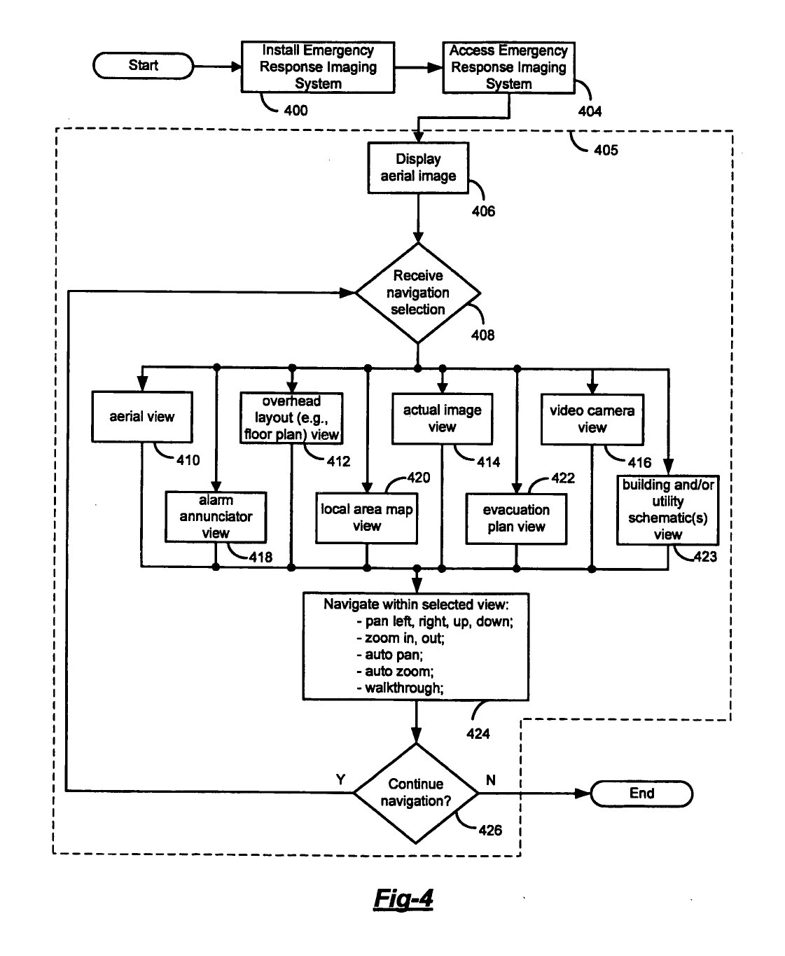

With reference to FIG. 4, steps to setup and operate the ERIS 10 are shown. In step 400, the ERIS 10 is installed. Installation and setup include initializing the data storage device 56 with the ERIS images and information necessary for operation. The images may include an aerial photograph, an overhead layout (e.g., a floor plan), which may be a diagram, an actual image of the location 14, which may be an interior or exterior photograph of the location 14, an evacuation plan, which may be a diagram, and other location images for ERIS use. The aerial photograph, the overhead layout, and the evacuation plan may be two dimensional overhead view type images.

The actual images, or panoramic views, may be actual location photographs of various places throughout the location. For example, the actual images may be taken at various rooms throughout the location 14 and may be the result of actual photographs taken at the location 14. The actual photographs may be taken with a normal two dimensional camera. The actual photographs may be also be taken with a rotating-type three hundred sixty degree camera that captures a digital image of an entire perspective of a room or area of the location. In other words, the camera may be placed in the center of a room to be photographed. The camera may then capture a digital photograph of the entire room taken from the perspective of the camera location by rotating on an axis perpendicular to the floor of the room.

A spherical type camera may also be used to capture an entire global perspective of a room. The spherical type camera may rotate on two axes, one that is perpendicular to the floor and one that is parallel to the floor. The image captured by the spherical type camera may include image data for parts of the room above and below the camera location. The type of camera used for the actual images will dictate the manner in which the actual images are viewed in the ERIS. When a three hundred sixty degree actual image is used, the user may view the image with pan left, pan right, zoom in, and zoom out operations. When a spherical actual image is used, the user may view the image with pan left, pan right, pan up, pan down, zoom in, and zoom out operations.

The actual images are stored in the data storage device 56. Each actual image is configured with links to physically corresponding, or adjacent, actual images. For example, an actual image of a room is stored and configured with links to any adjacent rooms, hallways, or other areas that are connected to the room.

As discussed in more detail below, the actual images are navigable such that a user may click on embedded links within each actual image to view the corresponding actual location image. In this way, the user may click on embedded links within each actual image to navigate through the building as if the user were actually walking through the building. The actual images are also navigable in that the user can view a selected actual image from a number of perspectives using pan left, pan right, pan up, pan down, zoom in, or zoom out operations. Thus, the actual images are navigable in two distinct ways. The actual images are navigable in that the user may navigate from one actual image to another actual image using embedded links. The actual images are also navigable in that the user may navigate within a selected actual image to view various perspectives of the selected actual image.

The navigable actual images may also be “stitched” together to give the appearance of a continuous location image. In such an embodiment, the user may navigate seamlessly between actual location images. In such an embodiment, the user may simply navigate or “walk” through the location 14. Location information, such as actual images, is also linked to related information.

When a user has navigated to a particular room of a location 14, and is viewing a selected navigable image, the user may then toggle between the actual navigable image and an overhead layout, for example a floor plan, that shows the current navigational position on the overhead layout in relation to the entire location 14, or an entire area of the location 14. When the overhead layout is viewed, it may be oriented to correspond to the orientation and perspective of the current view of the actual navigable image. In this way, data may be linked and navigated on multiple levels, including an overhead layout level and an actual navigable image, or panoramic view, level. For example, if a user views an actual navigable image of a particular room of a second floor of a location 14, then user may then toggle the display to view the overhead layout, or floor plan, of the second floor. When the user toggles to the overhead layout, the overhead layout will show the second floor, or that portion of the second floor corresponding to the location of the actual image. Further, the overhead layout may be oriented to the same orientation as last viewed in the actual image. Thus, if the user last viewed the actual image facing an east wall, for example, the overhead layout may be oriented to appear with the east direction at the top of the display.

In addition, video camera and microphone data and links may likewise be connected to actual image data and/or overhead layout data. For example, if a user has navigated to a particular room that includes video camera and microphone feeds, the user may open a new window to view such live feeds. Additionally, the ERIS 10 may be configured such that the live video or microphone feeds are automatically accessed when a certain room or location is viewed.

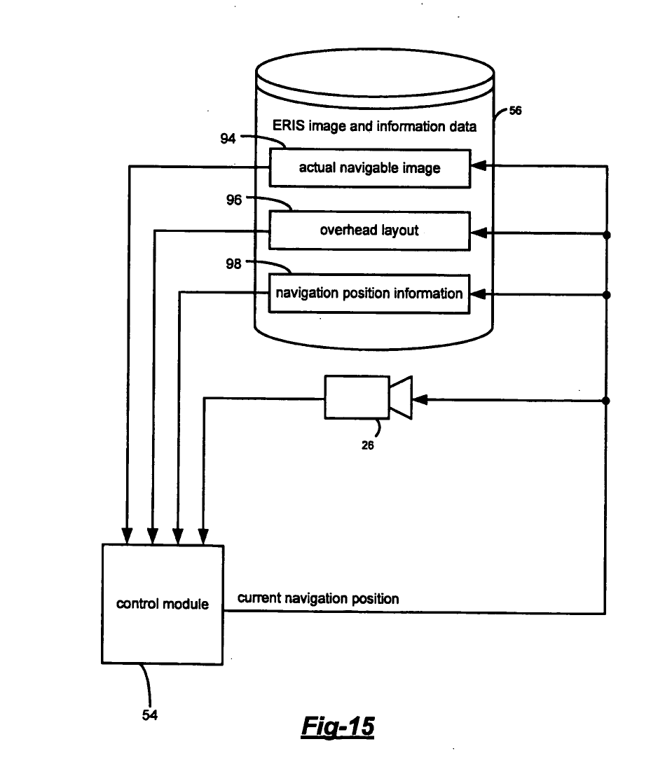

Referring to FIG. 15, the multiple levels of the ERIS data viewing and information options are shown. The levels are referenced by the current navigation position, as determined by the control module 54 based on the navigation input. Based on the current navigation position, the user may toggle between, and/or access, the current actual navigable image 94, the overhead layout 96, navigation position information 98, and output from a video camera 26 corresponding to the current navigation position. In this way, navigation may proceed on four levels. The user may navigate via the actual navigable images, as described above. As the user navigates, the current navigation position is updated. The user may navigate to new navigation positions via embedded links in the overhead layout as well.

For the selected current navigation position, the user may view the actual navigable image 94 associated with the current navigation position. The user may also view the overhead layout 96 from the perspective of the current navigation position, and also from the same orientation as viewed in the last actual navigable image view. The user may also view a live video camera feed, if one is available in the vicinity of the current navigation position. The user may also view navigation position information 98 for the current navigation position. The navigation position information 98 may include a description of the area surrounding the current navigation position, as well as emergency procedures, material safety data sheets, equipment operation manuals, including instructional videos, and schematic utility diagrams, such as electrical schematics, plumbing schematics, and the like. The schematics may be CAD files or dxf files, as described above. The navigation position information 98 may also include automated incident management forms. The automated incident management forms may be specific to a current response event. (Completion of the incident management forms may be required to document events and response actions, etc.). The navigation position information 98 may also include contact information for predetermined persons associated with the current navigation position or with the location 14.

Referring again to FIG. 4, after install and initialization, the ERIS 10 is accessed in step 404. The access may be made by response personnel during an emergency, for example.

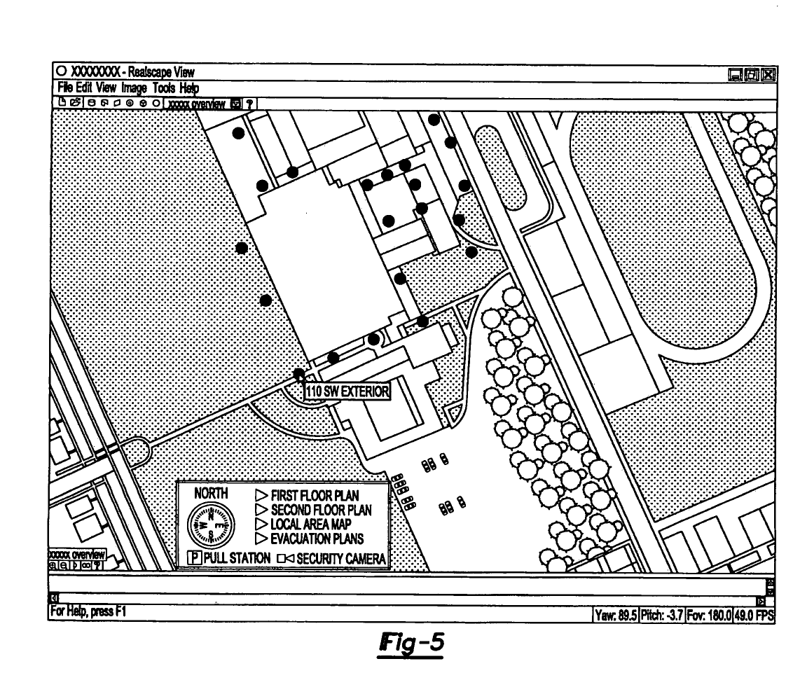

Operation of the ERIS 10 is now described in steps 406 through 426 and with additional reference to FIGS. 5 through 13. Steps performed by the ERIS are grouped at 405. The aerial image is displayed in step 406. (See FIG. 5). The aerial image is configured with various navigable links. The user may click on a link to an overhead layout, a local area map, or an evacuation plan. In addition, the user may click on an actual image link embedded within the aerial image. The actual image links are displayed as dots on the location aerial image.

When an actual image link is selected, the actual image of the physical place corresponding to the selected embedded link may be displayed. For example, when the user clicks on the location of the cafeteria, the actual image for the cafeteria is displayed. When the user holds the mouse selector over an actual image link, a short description of the actual image link appears. For example, in FIG. 5, the mouse pointer is over the actual image link to the “SW Exterior” actual image.

In step 408, the next navigation view selection is received. A number of navigation views may be selected, including an aerial view (step 410), an overhead layout (e.g. floor plan) view (step 412), an actual image view (step 414), a video camera view (step 416), an alarm annunciator view (step 418), a local area map view (step 420), an evacuation plan view (step 422), and a building or utility schematic view (step 423). As can be appreciated, the ERIS 10 may be configured with any additional images or data that may be helpful or desired for response.

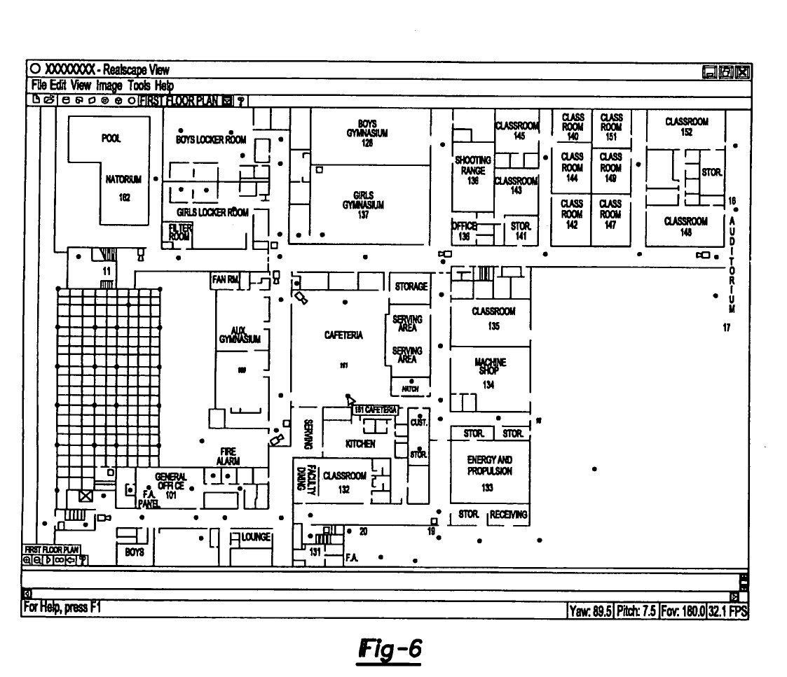

In step 412, an overhead layout view is selected. (FIG. 6). Like the aerial view, the overhead layout view contains embedded actual image links. The actual image links are displayed as dots in FIG. 6. In FIG. 6, the mouse pointer is over the cafeteria link. The floor plan may be a floor plan graphic image. The floor plan may also be a “dxf” (data exchange format) file converted from a CAD file. Additionally, the floor plan may be a CAD file. Additionally, a graphic file may be provided along with a “dxf” file and/or a CAD file for viewing by the user.

In step 424, the selected view may be navigated. The navigable options depend on the particular view. For example, when the aerial image or overhead layout are viewed, the navigation options include scroll left, right, up, or down.

In step 426, the user determines whether to continue navigation. When navigation is continued, the next navigation view selection is received in step 408.

In step 414, an actual image view is selected. The actual image view may be selected by clicking on an embedded actual image link in the aerial view, the overhead layout view, or another actual image view. The actual image view may be selected from a menu of listed actual images as well.

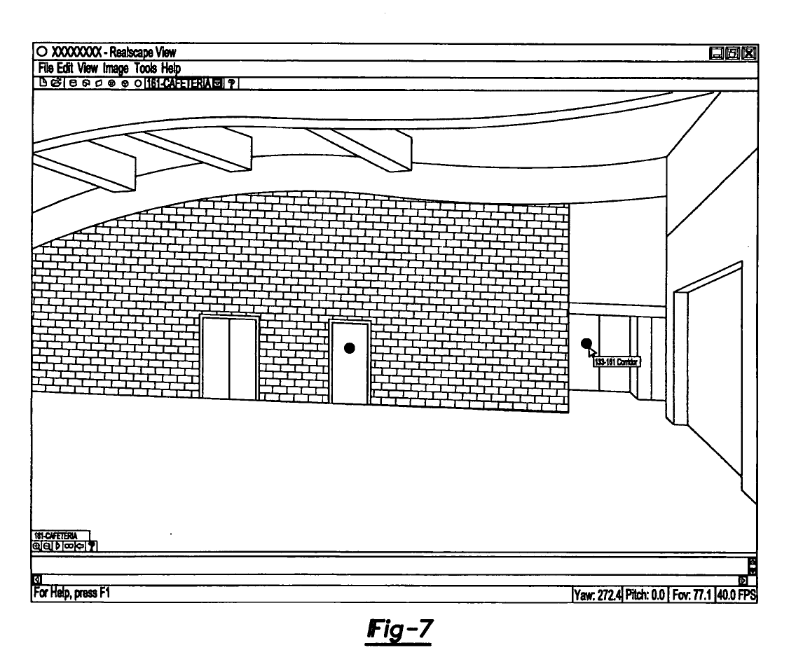

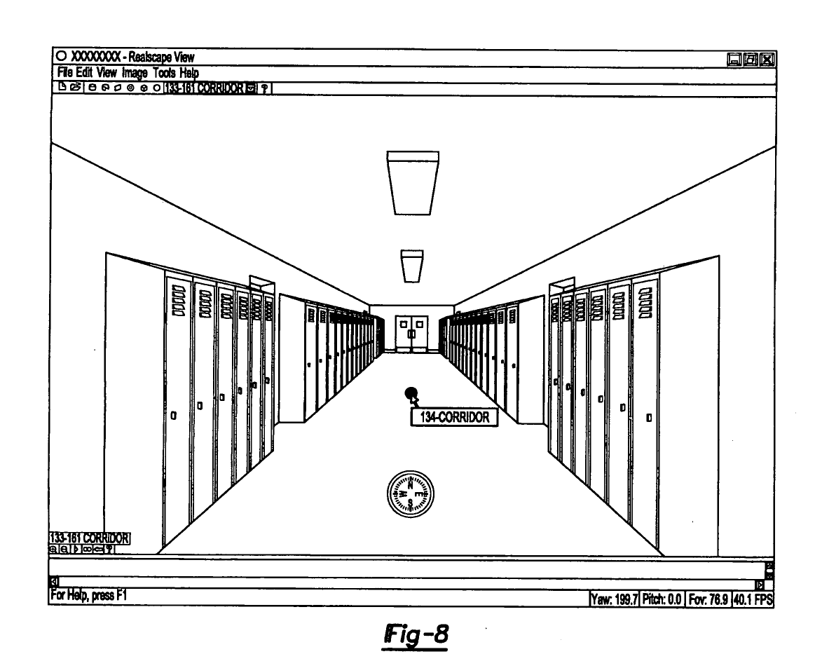

In FIG. 7, an actual image view of a cafeteria is illustrated. The actual image view of the cafeteria contains embedded links to other actual image views, including the corridor leading away from the cafeteria. By clicking on the embedded link to the corridor, the actual image of the corridor is displayed. (FIG. 8).

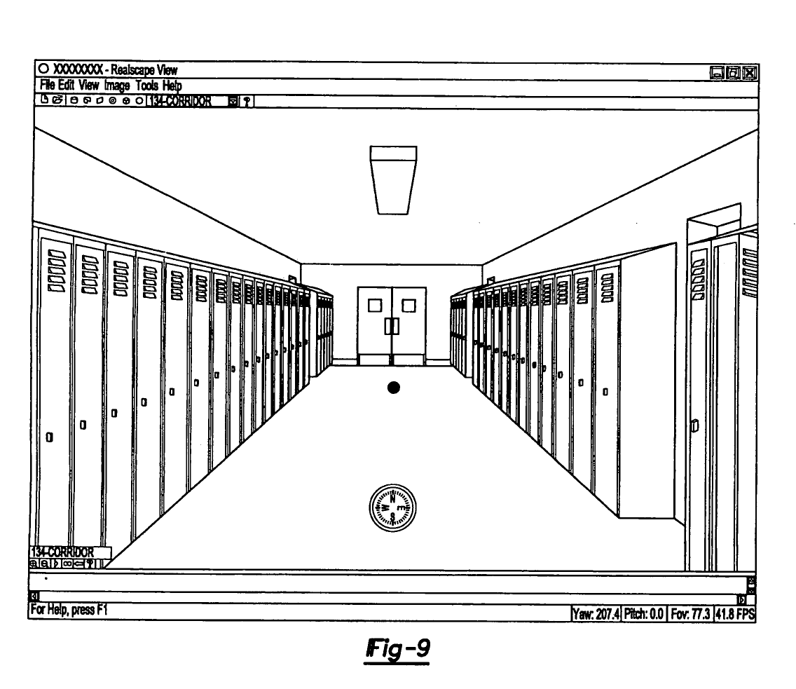

In FIG. 8, the actual image view of the corridor contains an embedded link to a location further down the corridor. By clicking on the embedded link, the location further down the corridor is displayed (FIG. 9).

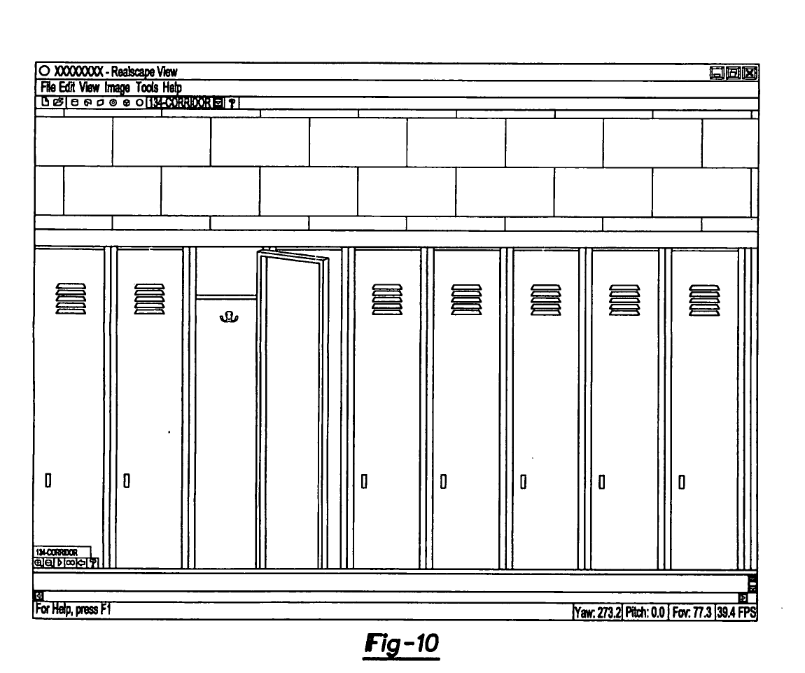

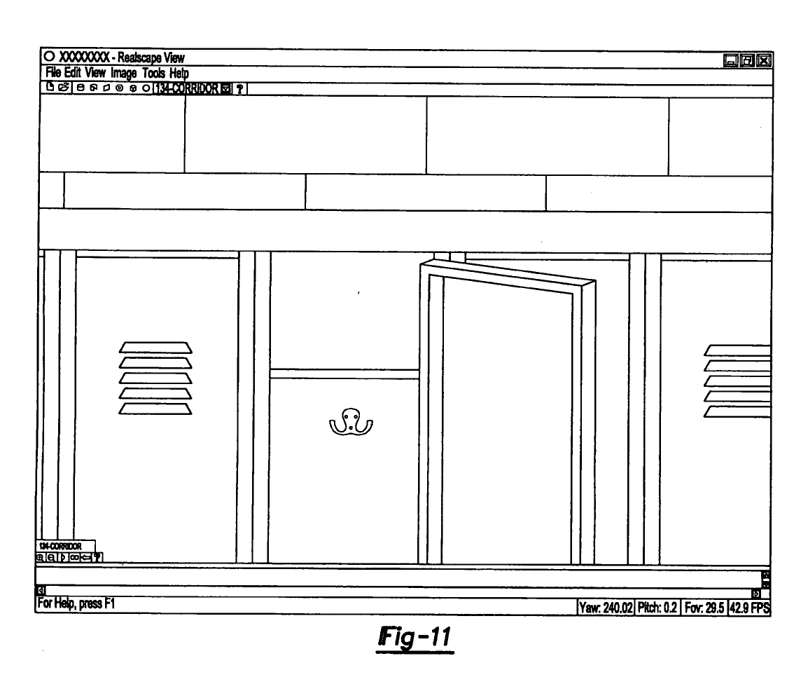

In step 424, the actual image is navigated. The user may pan left, right, up and down and zoom in and out. In FIG. 10, a pan right navigation has occurred. In FIG. 11, a zoom in operation has occurred.

In this way, the user may navigate through the location, viewing the entirety of each room in detail if desired. In this way, response personnel using the ERIS are able to quickly view the details, including the interior, of a location.

The actual image view may also include distance and dimension data. The distance from the camera perspective point, to the object in the center of the screen may be displayed. In other words, when a door is displayed, a distance from the camera location to the door may also be. displayed. As the actual image is navigated with pan left, pan right, the distance to the object may change.

In addition, dimensional data about the room or area corresponding to the current actual image may also be displayed. For example, the location and dimensions of all of the doors and windows in a particular room may be displayed. The distance and dimensional data between certain objects, such as doors and windows may also be displayed. Further, a dimensional overview may be selectively overlaid on the actual image such that distance estimates to all objects in the room may be displayed.

As can be appreciated, instead of using navigation by point-and-click, a navigation joystick or other navigation input device may be used. Navigation arrows may also be used, such as left, right, up, and down arrows. Further, navigation may be continuous. For example, the user may “walk through” the actual image towards an adjacent actual image link, such as a corridor. When the corridor is encountered, the corridor actual image may be displayed. In addition, actual image photographs may be stitched together to give the appearance of continuous flowing navigation.

The actual image may contain links to navigate to the previously viewed image or to return to the floor plan view. For example, by clicking on the compass graphic of FIG. 9, the floor plan image is displayed.

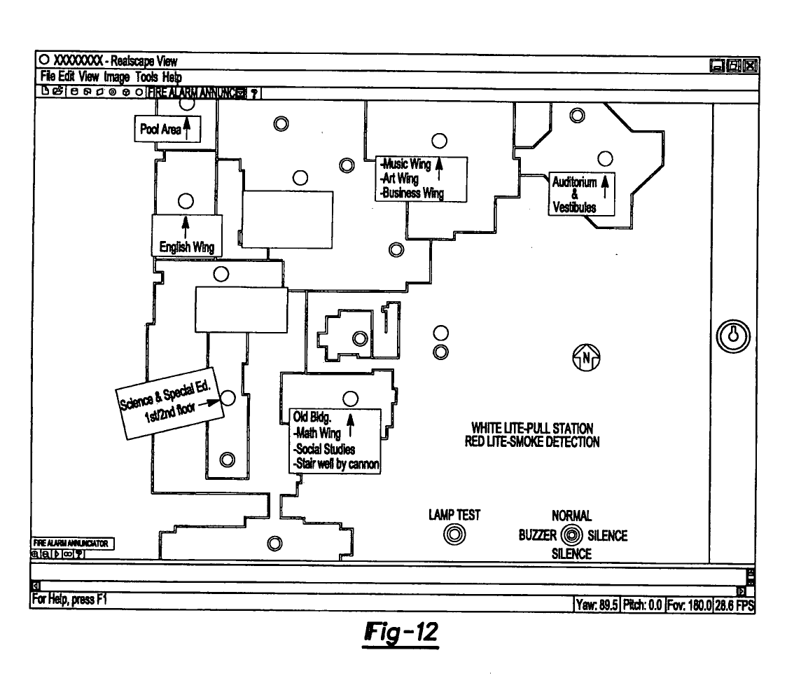

In step 418, an alarm annunciator view is displayed (FIG. 12). The alarm annunciator displays the location of fire alarms within the building. In FIG. 12, the alarm anunciator is an actual image of the building's alarm annunciator. The alarm annunciator view may be overlayed with actual fire alarm data such that the location of activated fire alarms is displayed.

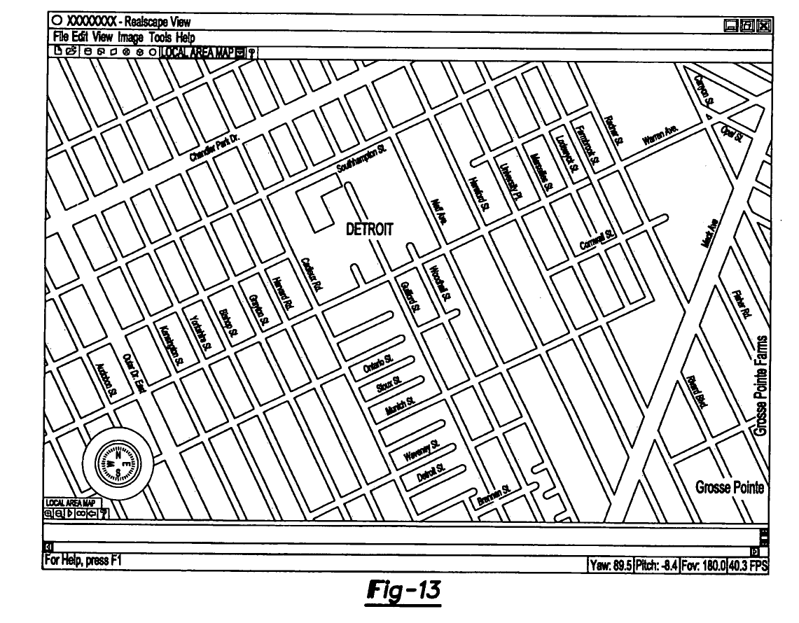

In step 420, a local area map view is displayed (FIG. 13). The local area map view may be navigable with scroll left, scroll right, scroll up, or scroll down, instructions.

In step 422, an evacuation plan view is displayed. The evacuation plan may include an overhead layout view with evacuation routes and exits noted.

In step 423, a building schematic view is displayed. The building schematics may include Heating Ventilation and Air Conditioning (HVAC) system diagrams, with locations of HVAC components noted. The building schematics may also include electrical diagrams, blue prints, water and sewer diagrams, construction plans, computer network diagrams, boiler room diagrams, and other suitable utility or building schematics.

Surveillance camera locations are displayed on the overhead layout view (FIG. 6). By clicking on video camera, the live surveillance camera feed is displayed. The live surveillance camera footage may be displayed in a “pop-up” window separate from the floor plan view window. The video camera may be controlled by up, down, left, and right inputs.

Response personnel may remain at an ERIS terminal 12 while the emergency operation proceeds to monitor activity within the location. In such case, ERIS operation may continue throughout the emergency.

The ERIS 10 may be configured with an operation log system. The operation log system may comprise writeable non-volatile memory located at the ERIS terminal 12 or ERIS server 21 for storing operation data. The operation data may include all operations or actions taken by the ERIS 10 during an emergency. In other words, all inputs received by the ERIS 10, and all displayed outputs may be stored. Further, all navigational input/output may be stored. In this way, after the emergency the ERIS 10 can be reviewed to determine exactly what was viewed at an ERIS terminal 12, and exactly what was done. The log will contain data regarding all actual images viewed, all video cameras viewed, all schematics and diagrams viewed, all motion sensors and microphones utilized etc. In addition, the video camera, microphone, and motion sensor data may be stored on the non-volatile memory.

It is anticipated that all components of the ERIS 10 may be configured with battery backup or alternative electrical power means. In this way the ERIS terminals 12 and ERIS server 21 may remain operational when main electrical power at the location 14 is terminated. The video cameras 26, microphones 28, and motion sensors 30 may also be configured with backup power means.

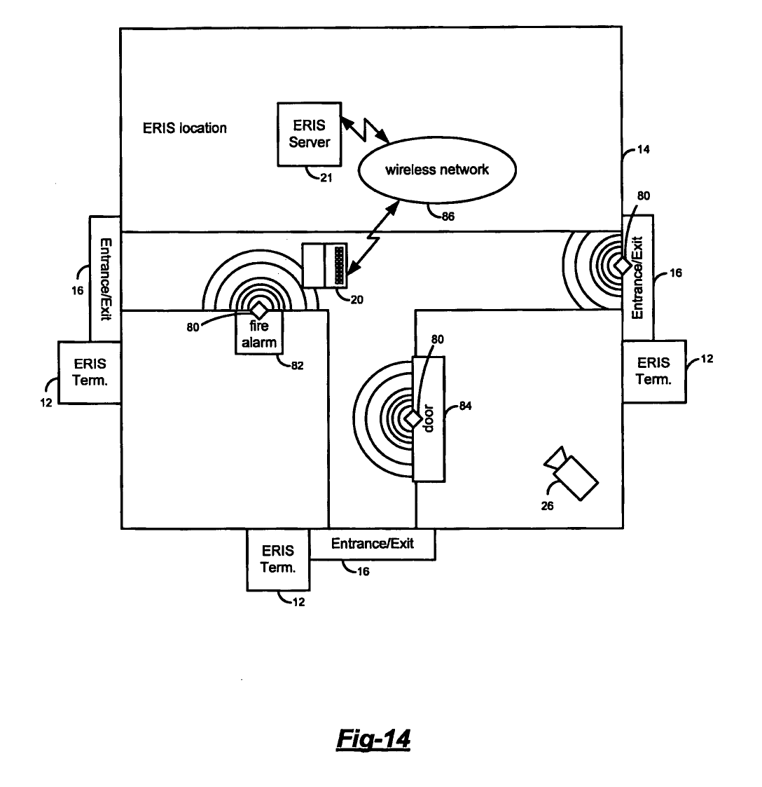

The location 14 may be configured with embedded RFID devices 80. As shown in FIG. 14, embedded RFID devices 80 may be located at a fire alarm 82, at an entrance/exit 16, or at an interior door. In FIG. 14, a portable computing device 20 is shown located in a hallway at the ERIS location 14. As described above, the portable computing device 20 may communicate with the ERIS server 21 via a wireless network 86. The portable computing device 20 may receive RFID information from the RFID devices 80. The RFID devices 80 may simply broadcast an identification code that the portable computing device 20 may recognize based on an ERIS server query. The portable computing device 20, based on the identification code, may determine that, for example, it is near a fire alarm 82. Depending on the number of embedded RFID devices 80 at the location, the RFID devices 80 may serve as a “you are here” type locator for the portable computing device as it is moved throughout the location.

In addition, communication with certain RFID devices 80 may trigger the portable computing device 20 to load certain designated data or take certain designated actions. For example, when the portable computing device 20 detects an RFID device 80 associated with a door 84, the portable computing device 20 may automatically determine whether a video camera 26 is located in the room associated with the door 84. When a video camera 26 is available, the portable computing device 20 may automatically display the particular video camera video feed. The portable computing device 20 may also load certain designated information about the room, such as its use for, its contents, etc. In addition, recognition of an RFID device 80 in the vicinity may trigger a video picture to be taken and stored.

The description is merely exemplary in nature and, thus, variations are intended to be within the scope of the teachings.

What is claimed is:

1. An imaging system for a location comprising:
a data storage device that stores a plurality of navigable actual images corresponding to a plurality of positions within said location and an overhead layout of said location; and
a control module with an input for a navigation input device and an output for a display device, that determines a current navigation position from said plurality of positions based on said input, that accesses said plurality of navigable actual images and said overhead layout, and that controls said output to display on said display device at least one of a view of a selected navigable actual image from said plurality and a view of said overhead layout;
wherein said view of said selected navigable actual image and said view of said overhead layout correspond to said current navigation position.

2. The imaging system of claim 1 further comprising:
a portable housing containing said control module, said navigation input device and said display device and configured with a first communication interface connected to said control module; and
a second communication interface connected to said data storage device and selectively connectable to said first communication interface;
wherein data corresponding to at least one of said selected navigable actual image and said overhead layout is communicated between said storage device and said control module through said first and second communication interfaces.

3. The imaging system of claim 2 wherein said location includes a building and wherein said second communication interface is located outside of said building.

4. The imaging system of claim 2 wherein said first and second communication interfaces communicate through at least one of a wired connection and a wireless connection.

5. The imaging system of claim 4 further comprising at least one RFID device located within said building wherein said control module is configured to detect said at least one RFID device and to receive information about a current actual position of said control module within said location based on said detection.

6. The imaging system of claim 1 further comprising a fixed housing containing said control module, said navigation input device and said display device and configured with a communication interface connected to said control module and to said data storage device, wherein said fixed housing is located at said location.

7. The imaging system of claim 6 wherein said location includes a building and wherein said fixed housing is located outside of said building.

8. The imaging system of claim 6 wherein said fixed housing is at least one of lockable and shockproof.

9. The imaging system of claim 1 further comprising a video camera at said location wherein said control module receives video images from said video camera and controls said output to display said video images on said display device when a position of said video camera corresponds with said current navigation position.

10. The imaging system of claim 9 wherein said control module controls said camera.

11. The imaging system of claim 1 wherein said selected navigable actual image is at least one of rotationally viewable and spherically viewable.

12. The imaging system of claim 1 wherein said selected navigable actual image and said overhead layout include at least one navigation link and wherein said current navigation position is updated to correspond with said at least one navigation link when said at least one navigation link is selected.

13. The imaging system of claim 1 wherein at least one of dimension data and distance data are overlayed with said selected navigable actual image within said view of said selected navigable actual image on said display device.

14. The imaging system of claim 1 wherein said overhead layout of said location includes at least one of an image file, a data exchange format file and a CAD file.

15. The imaging system of claim 1 further comprising:
a microphone and a motion sensor at said location; and
an audio output connected to said control module;
wherein said control module receives audio data from said microphone and motion sensor data from said motion sensor and outputs said audio data to said audio output when audio data is received.

16. The imaging system of claim 1 wherein said data storage device stores a history of selected navigable actual images and navigation input data.

17. The imaging system of claim 1 wherein said data storage device stores navigation position information corresponding to said current navigation position, including at least one of a description of an area surrounding said current navigation position, emergency procedures, material safety data sheets, equipment operation manuals, instructional videos, schematic utility diagrams, automated incident management forms, and contact information for predetermined persons and wherein said control module controls said output to display said position information.

18. A method comprising:
storing a plurality of navigable actual images of a location and an overhead layout of said location in a data storage device, each of said navigable actual images and said overhead layout being configured with at least one selectable navigational link;
displaying at least one of a view of a selected navigable actual image from said plurality and a view of said overhead layout on a display device, said view of said selected navigable actual image and said view of said overhead layout corresponding to a current navigation position within said location;
receiving navigational input from an input device, said navigational input including a selected navigational link;
updating said current navigational position based on said received navigational input.

19. The method of claim 18 further comprising receiving and displaying video images from a video camera within said location, a position of said video camera corresponding to said current navigational position.

20. The method of claim 19 further comprising:
moving said display device within said location;
receiving RFID data from RFID devices within said location;
receiving information about a current actual position of said display device based on said RFID data.
